(19) United States
(12) Patent Application Publication
(10) Pub. No.: US 2011/0073418 A1
(43) Pub. Date: Mar. 31, 2011

(54) DISK BRAKE FOR VEHICLE

(76) Inventor: Hak Soo KIM, Gyeonggi-do (KR)

(21) Appl. No.: 12/893,486

(22) Filed: Sep. 29, 2010

(30) Foreign Application Priority Data
Sep. 29, 2009 (KR) 10-2009-0092360

(51) Int. Cl. F16D 55/225; F16D 65/092

(52) U.S. Cl. 188/73.43

(57) ABSTRACT

Disclosed is a disk brake for a vehicle.

The disk brake includes an upper contact part closely making contact with an upper surface of a carrier, a coupling part connected to the upper contact part and coupled with a coupling protrusion formed in the carrier, a guide part connected to the coupling part and coupled between the slide groove provided at a lower portion of the coupling protrusion and a projection part formed in the pad plate, and a support part connected to the guide part to support a lower end of the projection part. The upper contact part closely makes contact with an outer surface of the carrier by passing through an internal surface and a top surface of the carrier coupled with the coupling part. One end of the upper contact part is fixed into a fixing groove in formed in the outer surface of the carrier. The upper contact part of the pad spring is fixedly inserted into the fixing groove of the carrier while closely making contact with the upper surface of the carrier, so that the pad spring is prevented from deviating from the initial mounting position thereof.

This application claims the benefit of Korean Patent Application No. 10-2009-0092360 filed on Sep. 29, 2009, in the Korean Intellectual Property Office, the disclosure of which is incorporated herein by reference.

### BACKGROUND

1. Field

The disclosure relates to a disk brake for a vehicle, and more particularly to a disk brake for a vehicle having an improved structure of pad springs that support pad plates such that the pad plates slidably move.

2. Description of the Related Art

In general, a disk brake for a vehicle forcibly presses disk pads against both lateral surfaces of a disk rotating with a wheel of the vehicle to generate friction force and stops the rotation of the disk by using the friction force, thereby braking the vehicle.

One example of the disk brake has been disclosed in Korean Unexamined Patent Publication No. 10-2008-0012466 that has been filed by applicant of the subject application.

The disclosed disk brake includes a pair of pad springs interposed between a side of a disk pad and a carrier to elastically support a lower portion of the disk pad such that the disk pad slidably moves.

The pad spring includes an upper contact part, a pair of coupling parts provided symmetrically to each other at both side portions of the upper contact part, a pair of guiding parts connected to the coupling parts, respectively, and support parts connected to the guiding parts. In this case, the upper contact part closely makes contact with one side of an upper portion of the carrier and includes an upper coupling member protruding outward.

Meanwhile, the pad spring may move according to the movement of the disk pad during the braking operation of the disk brake. As the braking operation repeats, the pad spring moves according to the movement of the disk pad, so that the pad spring may not be stably mounted between the disk pad and the carrier.

In other words, the conventional pad spring is supported between the disk pad and the carrier by the upper coupling member formed in the upper contact part. However, as the braking operation repeats, the pad spring may not be stably supported by the upper coupling, so that the pad spring may deviate from the initial mounting position thereof.

### SUMMARY

Accordingly, it is an aspect of the disclosure to provide a disk brake for a vehicle, capable of preventing a pad spring from deviating from the initial mounting position thereof.

Additional aspects and/or advantages of the disclosure will be set forth in part in the description which follows and, in part, will be apparent from the description, or may be learned by practice of the disclosure.

The foregoing and/or other aspects of the disclosure are achieved by providing a disk brake for a vehicle including a disk rotating with a wheel of the vehicle, a pair of pad plates provided at both lateral surfaces of the disk and including one surface attached to a friction pad and both ends having projection parts, a caliper housing including a cylinder in which a piston is installed to allow the pad plates to make contact with the disk, a carrier supporting the caliper housing and including slide grooves corresponding to the projection parts and coupling protrusions provided on the slide grooves, and a pad spring interposed between a side of each pad plate and the carrier to elastically support the pad plate and the carrier.

According to the disclosure, the pad spring includes an upper contact part closely making contact with an upper surface of the carrier, a coupling part connected to the upper contact part and coupled with the coupling protrusion, a guide part connected to the coupling part and coupled between the slide groove and the projection part, and a support part connected to the guide part to support a lower end of the projection part.

According to the disclosure, the upper contact part closely makes contact with an outer surface of the carrier by passing through an internal surface and a top surface of the carrier coupled with the coupling part.

According to the disclosure, a fixing groove is formed in the outer surface of the carrier.

According to the disclosure, one end of the upper contact part is fixedly inserted into the fixing groove.

As described above, the disk brake for the vehicle according to the disclosure can prevent the pad spring from deviating from the initial mounting position thereof because the upper contact part is inserted into the fixing groove formed in the outer surface of the carrier while closely making contact with the whole upper surface of the carrier.

### BRIEF DESCRIPTION OF THE DRAWINGS

These and/or other aspects and advantages of the disclosure will become apparent and more readily appreciated from the following description of the embodiments, taken in conjunction with the accompanying drawings of which:

FIG. 1 is a perspective view showing a disk brake according to one embodiment of the disclosure;

FIG. 2 is a perspective view showing a pad spring of FIG. 1; and

FIG. 3 is a sectional view showing the coupling relation of the pad spring of FIG. 1.

### DETAILED DESCRIPTION OF THE EXEMPLARY EMBODIMENTS

Reference will now be made in detail to the embodiments of the disclosure, examples of which are illustrated in the accompanying drawings, wherein like reference numerals refer to the like elements. The embodiments are described below to explain the disclosure by referring to the figures.

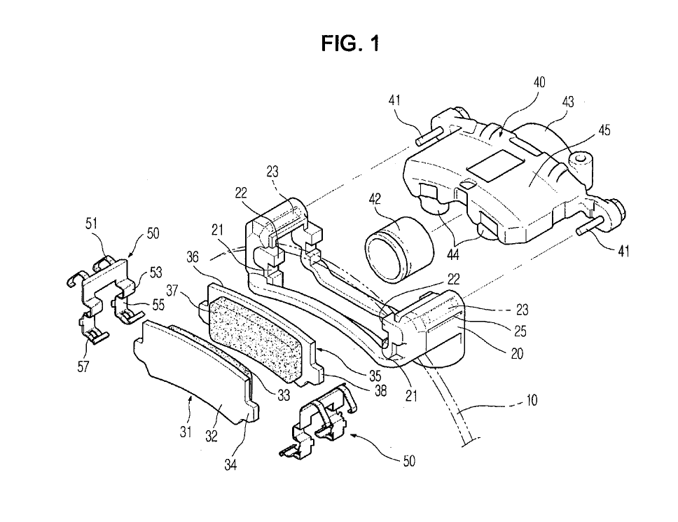

As shown in FIG. 1, a disk brake according to the disclosure includes a disk 10 that rotates with a wheel (not shown) of a vehicle, inner and outer disk pads 31 and 35 that are provided at both lateral surfaces of the disk 10, respectively, to press both lateral surfaces of the disk 10, respectively, to brake the disk 10, a caliper housing 40 and a piston 42 used to press the inner and outer disk pads 31 and 35, and a carrier 20 used to support the inner and outer disk pads 31 and 35 and the caliper housing 40.

The carrier 20 supports the inner and outer disk pads 31 and 35 such that the inner and outer disk pads 31 and 35 move back from the lateral surfaces of the disk 10 and move toward the lateral surfaces of the disk 10. To this end, slide grooves 21 are provided at both inner side portions of the carrier 20 corresponding to projection parts 34 and 38 provided in the inner and outer disk pads 31 and 35, respectively.

Coupling protrusions 22 are provided on the slide grooves 21 provided at both inner side portions of the carrier 20, and guide holes 23 are provided in parallel to the slide grooves 21 at both side portions of upper portions of the carrier 20.

The inner and outer disk pads 31 and 35 include pad plates 32 and 36, and friction pads 33 and 37 coupled with internal surfaces of the pad plates 32 and 36. The pad plates 32 and 36 are provided at both ends thereof with the projection parts 34 and 38 as described above, and are coupled with the slide grooves 21 to slidably move along the slide grooves 21. In this case, when the pad plates 32 and 36 move back and forth along the slide grooves 21, the friction pads 33 and 37 closely make contact with both lateral surfaces of the disk 10 so that braking force is generated.

The caliper housing 40 is movably mounted on the carrier 20 by a pair of guide rods 41 slidably inserted into the guide holes 23, respectively. The caliper housing 40 includes a cylinder 43 in which the piston 42 is mounted such that the piston 42 may move back and forth to press the inner and outer disk pads 31 and 35, a finger part 44 that press the inner and outer disk pads 31 and 35, and a connection part 45 that connects the finger part 44 with the cylinder 43.

The piston 42 is installed in the cylinder 43 such that the piston 42 moves back and forth. If braking pressure is applied to the cylinder 43, the piston 42 moves forth while pressing the inner and outer disk pads 31 and 35.

The carrier 20 is provided at both sides thereof with pad springs 50, which elastically support both ends of the inner and outer disk pads 31 and 35 while guiding the back-and-forth movement of the inner and outer disk pads 31 and 35.

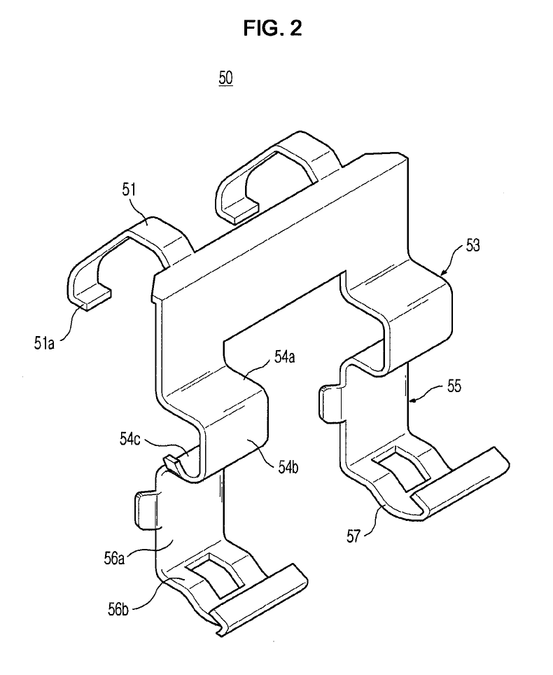

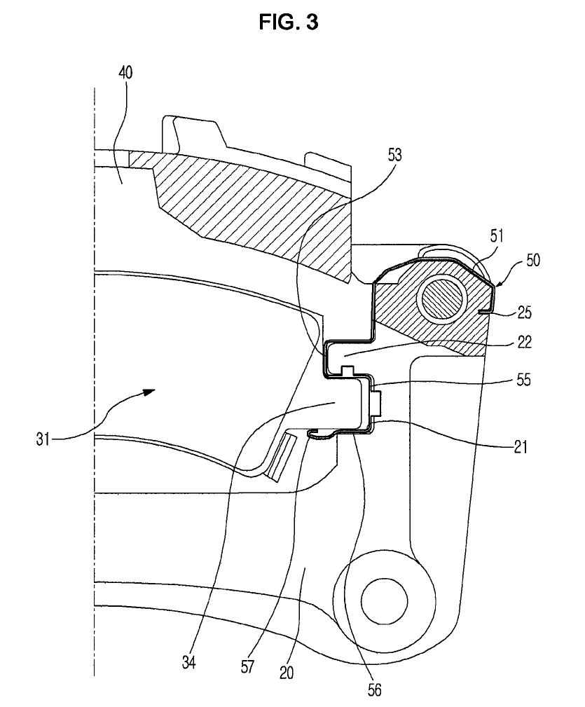

As shown in FIGS. 2 and 3, the pad spring 50 includes a thin steel plate having elasticity, and includes upper contact parts 51, coupling parts 53 connected with the upper contact parts 51, guiding parts 55 connected with the coupling parts 53, and support parts 57 connected with the guiding parts 55.

The upper contact parts 51 closely make contact with an upper surface of the carrier 20, and the details thereof will be described below.

The coupling part 53 allows the pad spring 50 to be stably coupled with the carrier 20 so that the pad spring 50 is not separated from the carrier 20. The coupling part 53 is shape-coupled to the coupling protrusion 22 of the carrier 20, and has a concave pattern in which the coupling protrusion 22 is inserted.

In other words, the coupling parts 53 include first horizontal parts 54a bent toward the pad plates 32 and 36 from the upper contact parts 51, that is, bent inward, first vertical parts 54b bent downward from the first horizontal parts 54a, and second horizontal parts 54c bent outward from the first vertical parts 54b.

The guiding parts 55 are interposed between the slide groove 21 of the carrier 20 and the projection parts 34 and 38 of the pad plates 32 and 36 corresponding to the slide groove 21. The guiding parts 55 have a concave pattern which is concaved inversely to the concave pattern of the coupling part 53 such that the projection parts 34 and 38 slide along the slide groove 21. Accordingly, when the braking operation of the disk brake is performed, the guiding parts 55 allow the pad plates 32 and 36 to deliver braking force to the carrier 20.

As shown in drawings, the guiding part 55 includes a second vertical part 56a bent downward from the second horizontal part 54c and a third horizontal part 56b bent inward from the second vertical part 56a. In other words, the guiding part 55 is recessed such that the projection parts 34 and 38 of the pad plates 32 and 36 slid along the slide groove 21 of the carrier 20, so that the pad plates 32 and 36 deliver braking force to the carrier 20 when the braking operation of the brake is performed.

The support parts 57 support lower portions of the projection parts 34 and 38 of the pad plates 32 and 36, and extend from the third horizontal parts 56b toward the projection parts 34 and 38 of the pad plates 32 and 36 while being slightly curved. Ends of the support parts 57 are smoothly bent toward the guiding parts 55 such that the projection parts 34 and 38 of the pad plates 32 and 36 smoothly slide.

According to the embodiment of the disclosure, even if the braking operation of the disk brake is repeatedly performed, the upper contact part 51 prevents the pad spring 50 from deviating from an initial mounting position thereof by stably supporting the pad spring 50.

As shown in drawings, the upper contact part 51 closely makes contact with an outer surface of the carrier by passing through an internal surface and a top surface of the carrier 20 coupled with the first horizontal part 54a of the coupling part 53. In other words, the upper contact part 51 closely makes contact with the whole upper surface of the carrier 20 while surrounding the whole upper surface of the carrier 20.

One end of the upper contact part 51 disposed on the outer surface of the carrier 20 is inserted into a fixing groove 25 formed in the outer surface of the carrier 20.

Therefore, when the braking operation of the disk brake is performed, the pad springs 50 according to the disclosure can elastically support both ends of the inner and outer disk pads 31 and 35. In addition, when the back-and-forth movement of the inner and outer disk pads 31 and 35 is guided, one end of the pad springs 50 surrounding the whole upper surface of the carrier 20 is inserted into the fixing groove 25 formed in the outer surface of the carrier 20, so that the pad springs 50 are prevented from deviating from the initial mounting position thereof.

Although few embodiments of the disclosure have been shown and described, it would be appreciated by those skilled in the art that changes may be made in these embodiments without departing from the principles and spirit of the disclosure, the scope of which is defined in the claims and their equivalents.

What is claimed is:

1. A disk brake for a vehicle comprising:
a disk rotating with a wheel of the vehicle;
a pair of pad plates provided at both lateral surfaces of the disk and having one surface attached to a friction pad and both ends having projection parts;
a caliper housing comprising a cylinder in which a piston is installed to allow the pad plates to make contact with the disk;
a carrier supporting the caliper housing and comprising slide grooves corresponding to the projection parts and coupling protrusions provided on the slide grooves; and
a pad spring interposed between a side of each pad plate and the carrier to elastically support the pad plate and the carrier,
wherein the pad spring comprises:
an upper contact part closely making contact with an upper surface of the carrier,
a coupling part connected to the upper contact part and coupled with the coupling protrusion;
a guide part connected to the coupling part and coupled between the slide groove and the projection part; and
a support part connected to the guide part to support a lower end of the projection part, and
wherein the upper contact part closely makes contact with an outer surface of the carrier by passing through an internal surface and a top surface of the carrier coupled with the coupling part.

2. The disk brake of claim 1, wherein a fixing groove is formed in the outer surface of the carrier.

3. The disk brake of claim 2, wherein one end of the upper contact part is fixedly inserted into the fixing groove.
